(19) United States
(12) Patent Application Publication
(10) Pub. No.: US 2006/0291934 A1
(43) Pub. Date: Dec. 28, 2006

(54) Method for generating a perforation clip region

(75) Inventors: Stephen Paul Adams, Lexington, KY (US); Michael Joseph Dattilo, Lexington, KY (US); Brent Allen Schanding, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/169,063

(22) Filed: Jun. 28, 2005

(51) Int. Cl. B41J 5/30

(52) U.S. Cl. 400/62

(57) ABSTRACT

A method for generating a perforation clip region includes defining a shape of a desired perforation pattern on a display screen; inserting at least one image onto the display screen in association with the perforation pattern; and previewing a combined image of the perforation pattern and the at least one image.

### BACKGROUND OF THE INVENTION

1. Field of the Invention

The present invention relates to an imaging apparatus having perforating capabilities, and more particularly, to a method for generating a perforation clip region.

2. Description of the Related Art

Various devices are available for performing perforation and/or cutting operations. However, many such devices are used in commercial applications, and are generally cost prohibitive to lower volume users. Also, such devices are often standalone devices, requiring the purchase of additional hardware. Some efforts have been directed to incorporating perforation or cutting devices into an imaging apparatus.

A need exists for a user to be able to define a perforation boundary around an area and to perform operations with respect to the area as desired by the user.

### SUMMARY OF THE INVENTION

The invention, in one form thereof, is directed to a method for generating a perforation clip region, including defining a shape of a desired perforation pattern on a display screen; inserting at least one image onto the display screen in association with the perforation pattern; and previewing a combined image of the perforation pattern and the at least one image.

The invention, in another form thereof, is directed to an imaging apparatus. The imaging apparatus includes a display screen, a printing unit, and a perforating unit. A processor is communicatively coupled to the display screen, the printing unit and the perforating unit. The processor processes job data for use by at least one of the printing unit and the perforating unit. The processor executes program instructions for defining a shape of a desired perforation pattern on the display screen; inserting at least one image onto the display screen in association with the perforation pattern; and previewing a combined image of the perforation pattern and the at least one image.

The present invention, in another form thereof, is directed to an imaging system. The imaging system includes a host, and an imaging apparatus communicatively coupled to the host. The imaging apparatus includes a printing unit and a perforating unit. A processor is associated with at least one of the host and the imaging apparatus. The processor is communicatively coupled to the printing unit and the perforating unit. The processor executes program instructions for defining a shape of a desired perforation pattern on a display screen; inserting at least one image onto the display screen in association with the perforation pattern; and previewing a combined image of the perforation pattern and the at least one image.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system embodying the present invention.

FIG. 2 is a general flowchart of a method for generating a perforation clip region, in accordance with the present invention.

FIGS. 3-5 illustrate an exemplary menu screen that is used in creating a perforation pattern, in accordance with the present invention.

FIG. 6 illustrates an exemplary menu screen, where the user is given the option to add text to a preview region including the perforation pattern of FIGS. 3-5.

FIG. 7 illustrates an exemplary menu screen, where the user is given the option to add an image to the preview region including the perforation pattern of FIGS. 3-5.

Corresponding reference characters indicate corresponding parts throughout the several views. The exemplifications set out herein illustrate one or more embodiments of the invention, and such exemplifications are not to be construed as limiting the scope of the invention in any manner.

### DETAILED DESCRIPTION OF THE INVENTION

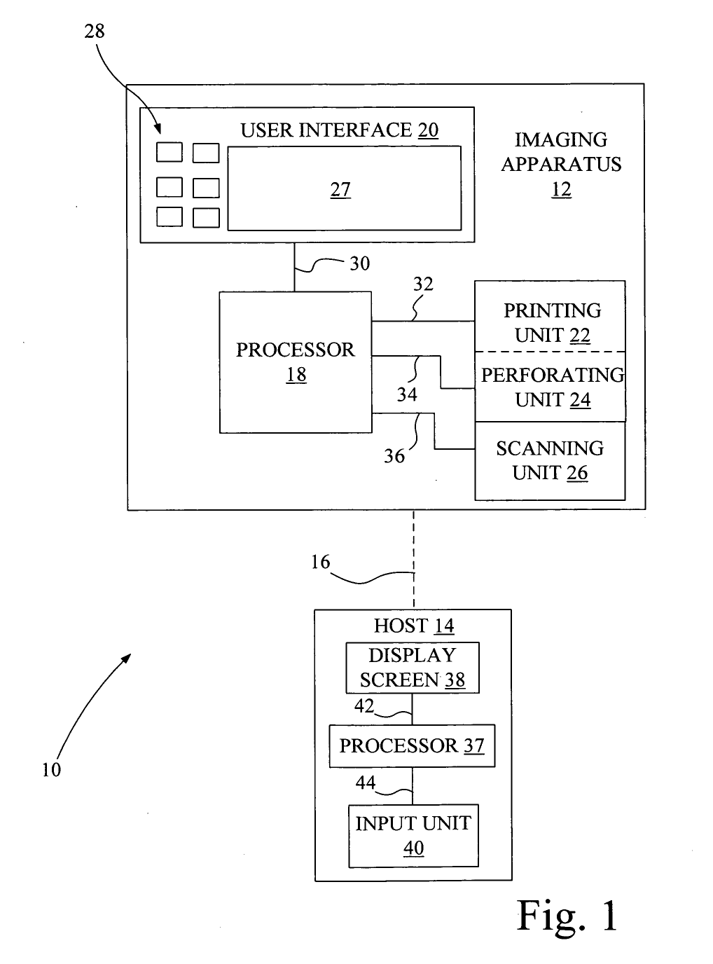

Referring now to the drawings and particularly to FIG. 1, there is shown an imaging system 10 embodying the present invention. Imaging system 10 includes an imaging apparatus 12, and optionally, a host 14.

Imaging apparatus 12 may be, for example, a combined printer/perforating apparatus, and may take the form of a multi-function device (MFD), such as for example, a standalone unit that has perforating, scanning, copying, and/or faxing functionality, in addition to printing functionality. Host 14, which may be optional, may be communicatively coupled to imaging apparatus 12 via a communications link 16. Communications link 16 is depicted as a dashed line to represent the optional coupling of imaging apparatus 12 to host 14.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

Imaging apparatus 12 includes a processor 18, a user interface 20, a printing unit 22, a perforating unit 24, and a scanning unit 26. With the present invention, it may be advantageous in some embodiments for perforating unit 24 to be combined with printing unit 22 in a single imaging apparatus, as shown in FIG. 1. However, those skilled in the art will recognize that the principles of the present invention may be achieved in systems where perforating unit 24 is independent from printing unit 22.

Processor 18 of imaging apparatus 12 may be, for example, an application specific integrated circuit (ASIC) having processing capabilities, and may include a microprocessor and associated memory. Processor 18 is communicatively coupled to user interface 20 via a communications link 30. Processor 18 is communicatively coupled to printing unit 22 via a communications link 32. Processor 18 is communicatively coupled to perforating unit 24 via a communications link 34. Processor 18 is communicatively coupled to scanning unit 26 via a communications link 36.

Processor 18 executes program instructions, in firmware or software, to provide operational control of printing unit 22 and a perforating unit 24. In some embodiments of imaging apparatus 12, such as for example where imaging apparatus 12 is a multifunction device (MFD), processor 18 may include in its memory a software or firmware program including program instructions that function as a driver for printing unit 22 and/or perforating unit 24, and will be referred to herein as a driver program. The driver program, for example, may include a halftoning unit and a data formatter subroutine that places print data and print commands in a format that can be recognized by printing unit 22, and may include a perforating driver subroutine for identifying perforation boundaries, and for placing perforation data in a format that can be recognized by perforating unit 24.

In addition, processor 18 executes program instructions to process job data for use by at least one of printing unit 22 and perforating unit 24. The job data may include, for example, perforating data and printing data generated as a result of executing program instructions to perform a method for generating a perforation clip region, e.g., to form a perforated template, in accordance with the present invention. The job data may be data generated locally, as when imaging apparatus 12 is operating in a standalone mode. Alternatively, the job data may be generated remotely, as when a perforation application is executed by host 14.

User interface 20 includes a display screen 27 and a plurality of input devices 28. Display screen 27 may be, for example, a liquid crystal display (LCD). Display screen 27 may display, for example, a preview of the perforating operation to be performed. The plurality of input devices 28 may include, for example, a plurality of buttons, and a pointer device, such as a joystick or trackball. Each of the plurality of input devices 28 is communicatively coupled to processor 18 via communications link 30. Processor 18 executes program instructions to receive a status of each of the plurality of input devices 28.

Printing unit 22 may be, for example, an ink jet print engine, or other suitable print engine for forming an image on a sheet of media, such as a sheet of paper, or label stock. The print engine may be, for example, an ink jet print engine having a reciprocating printhead carrier for transporting one or more ink jet printheads for performing a printing operation, the operation of which is well known in the art.

Perforating unit 24 may include, for example, a perforation device for forming perforations, i.e., holes, at a predetermined spacing, i.e., perforation density, in the sheet of media. One example of a perforation device, which can also be used for cutting, includes a reciprocating needle assembly that may be attached to the printhead carrier of the printing unit 22.

Scanning unit 26 may include, for example, a scan bed for receiving a document to be scanned. For example, during a scanning operation the media to be scanned may be placed on the document glass of the scan bed, and a scan bar may be moved in relation to the object to form a scanned image of the object.

In embodiments including host 14, host 14 may be, for example, a personal computer including a processor 37, a display screen 38 (e.g., a monitor device) and an input unit (e.g., keyboard) 40, and associated input/output (I/O) interfaces. Processor 37 may include, for example, a microprocessor and associated memory, such as RAM, ROM, NVRAM, and a mass data storage device, such as a hard drive, CD-ROM and/or DVD units.

Processor 37 is communicatively coupled to display screen 38 via communications link 42. Processor 37 is communicatively coupled to input unit 40 via communications link 44. Further, processor 37 is communicatively coupled to processor 18 of imaging apparatus 12 via communication link 16.

In embodiments that include host 14, host 14 may include in its memory all, or a portion, of the driver program including program instructions that function as a driver for imaging apparatus 12. The driver program, for example, may include a halftoning unit and a data formatter subroutine that places print data and print commands in a format that can be recognized by printing unit 22, and may include a perforating driver subroutine for identifying perforation boundaries, and for placing perforation instructions or data in a format that can be recognized by perforating unit 24. In addition, processor 18 executes program instructions to process job data for use by at least one of printing unit 22 and perforating unit 24. The driver program may be accessed, for example, by a software application, such as for example, a word processing application, a perforation application, etc., that is executing on host 14.

In accordance with the present invention, a preview of a selected perforating operation may be displayed on display screen 27 of imaging apparatus 12 and/or on display screen 38 of host 14.

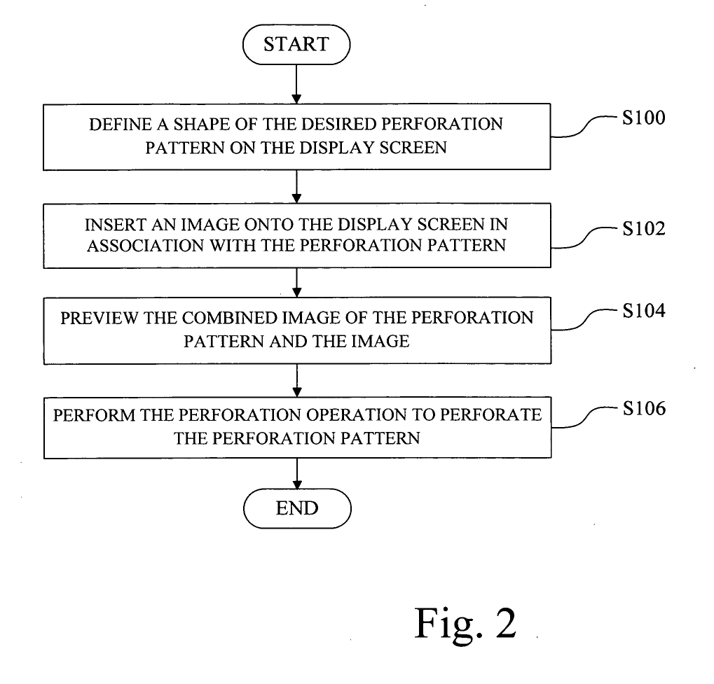

FIG. 2 is a general flowchart of a method for generating a perforation clip region, in accordance with the present invention. The process steps described below may be performed, for example, by program instructions executed by a processor, such as processor 18 of imaging apparatus 12 or processor 37 of host 14, with interactive input being received from a user via a series on menus screens displayed on display screen 27 of imaging apparatus 12 and/or on display screen 38 of host 14.

At step S100, a shape of a desired perforation pattern is defined on a display screen, such as display screen 27 and/or display screen 38. The desired perforation pattern may be generated in a variety of ways. For example, from the interactive menus displayed on display screen 27 and/or display screen 38, a plurality of selectable options for selecting the desired perforation pattern may be displayed. Template generation may be initiated by actuation of the Define Template button.

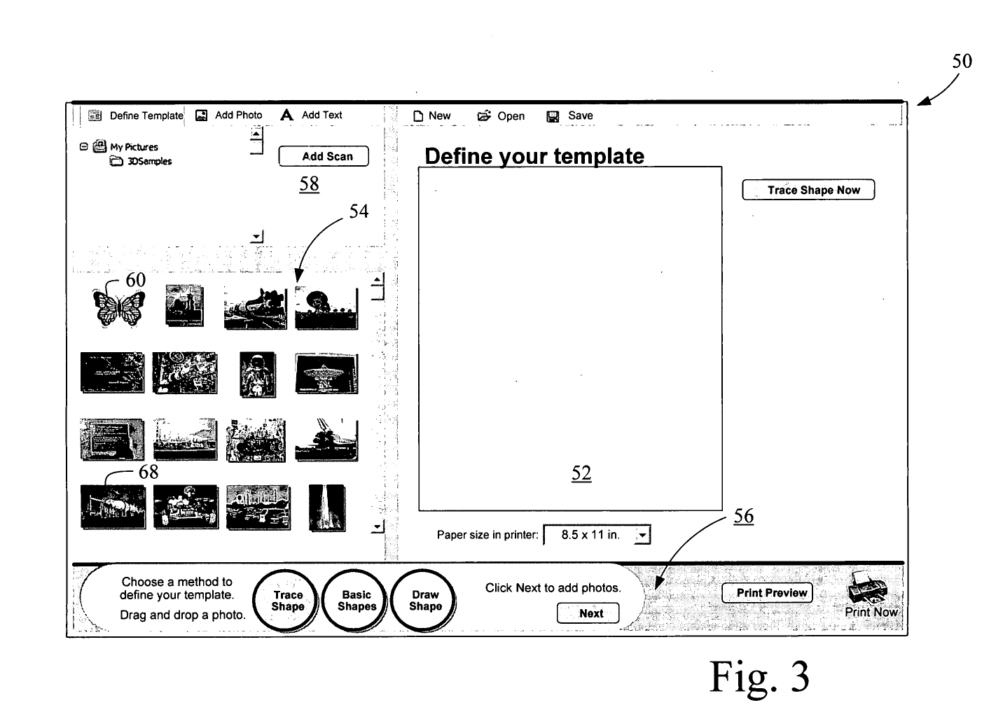

FIGS. 3-5 illustrate an exemplary menu screen 50 that may be displayed on display screen 27 and/or display screen 38 to aid the user in generating a perforation clip region. The perforation clip region may be used, for example, to form a perforated object, or alternatively, to form a template, which may be defined in a preview region 52.

For example, a new file is started by clicking on, i.e., selecting, the New icon. The Open icon permits the user to open an exiting perforation pattern, e.g., template. As another example, the Open icon may be used to select a file, such as My Pictures, and in doing so a plurality of photos and/or graphics images may be displayed as selectable image items a thumbnail region 54. Options are provided to the user in lower bar 56 of menu screen 50, and in supplemental region 58, so that the user may choose a method to define a shape of the desired perforation pattern.

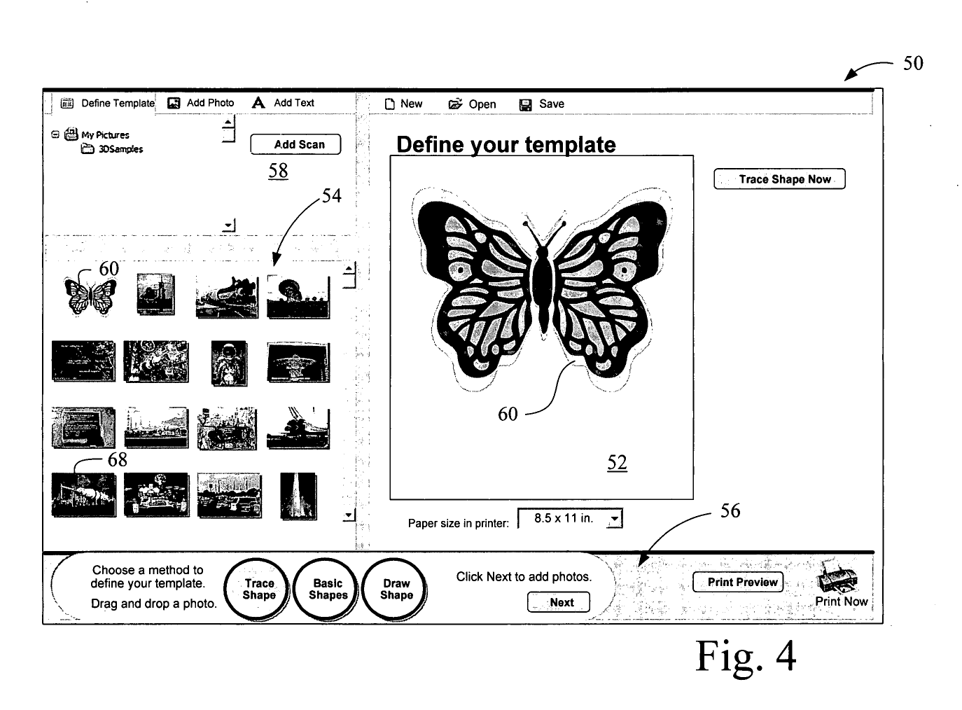

The perforation pattern may be automatically created by determining a boundary of an object from a pre-existing image. The pre-existing image may be retrieved from a database of images. For example, as illustrated in FIG. 4, the perforation boundary may be generated automatically by dragging a photo 60 from thumbnail region 54 and dropping photo 60 in preview region 52. Each thumbnail in thumbnail region 54 corresponds to a photo stored in an image database accessible by processor 18 and/or processor 37. The image database may be located, for example, in memory of imaging apparatus 12 and/or host 14.

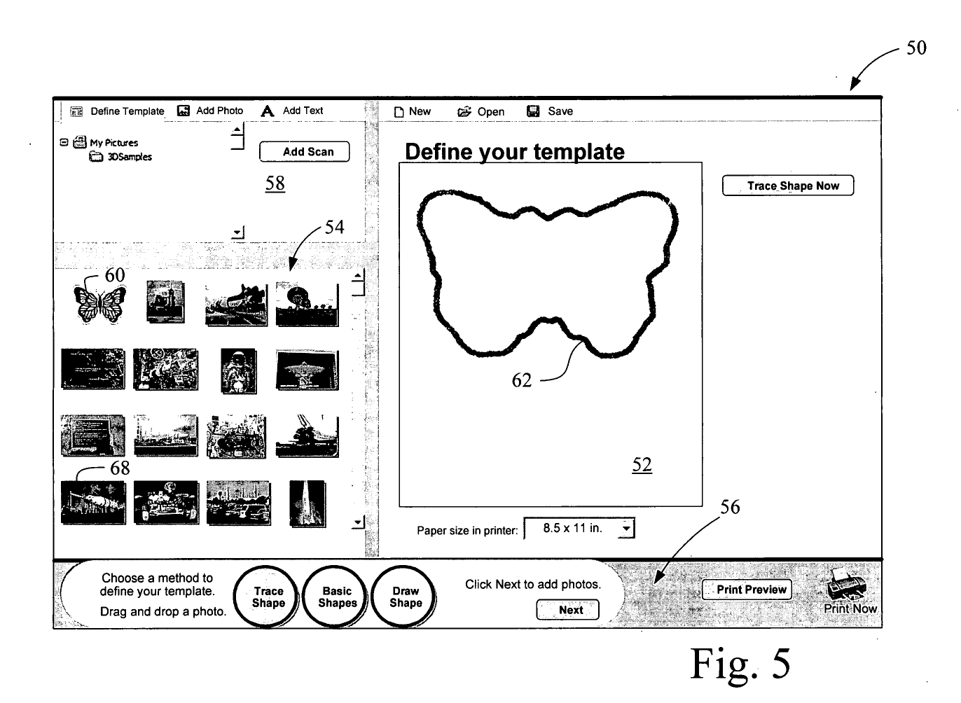

Thereafter, as illustrated in FIG. 5, a boundary of a predominant object in photo 60 may be automatically determined as a perforation pattern 62, such as for example, by separating the object from the background based on color change. The coordinates of the boundary of perforation pattern 62 may be saved in a database of perforation patterns, e.g., templates, by clicking on the Save icon. The database of perforation patterns may be located in memory of imaging apparatus 12 and/or host 14.

Alternatively, as also illustrated in menu screen 50, the user may select to define the perforation pattern by tracing the shape of an object; selecting from basic shapes; or, by drawing a shape.

The tracing of a shape of the perforation pattern may be performed, for example, by clicking on the Add Scan button in supplemental region 58, wherein the scanned image is displayed in preview region 52. The user may then manually trace the pre-existing scanned image of the object using a pointer input device, such as the pointer associated with a mouse input device. The coordinates of the traced shape of the boundary of the perforation pattern may be saved in the database of perforation patterns, e.g., templates, by clicking on the Save icon.

The basic shapes may include, for example, such shapes as a circle, square, triangle, which in turn can be reshaped by dragging the current shape to the desired shape using the pointer input device.

Likewise, the user may simply draw a shape in preview region 52 to be used as the perforation pattern using the pointer input device. Alternatively, the perforation pattern may be manually traced around a pre-existing image, such as a photo retrieved from a database of images, and selected via thumbnail region 54. The database of images may be located, for example, in memory of imaging apparatus 12 and/or host 14.

In addition to the features described above, menu screen 50 includes a Print Preview button, which when actuated, provides a visual representation of the perforation pattern, such as perforation pattern 62, in relation to the sheet of media on display screen 27 and/or display screen 38. Also, menu screen 50 includes a Print Now button that allows the user to immediately print the perforation pattern on the desired size of media. Further, the perforation pattern may be copied and inserted into preview region 52, or another document, if the selected media size will accommodate the replication.

At step S102, an image, such as photo 68, may be inserted onto display screen 38, and more particularly, into preview region 52 in association with the perforation pattern 62. The image may be selected from a plurality of selectable images displayed on display screen 27 and/or display screen 38. The plurality of selectable images may include, for example, at least one of a photo and a graphics image and a text image.

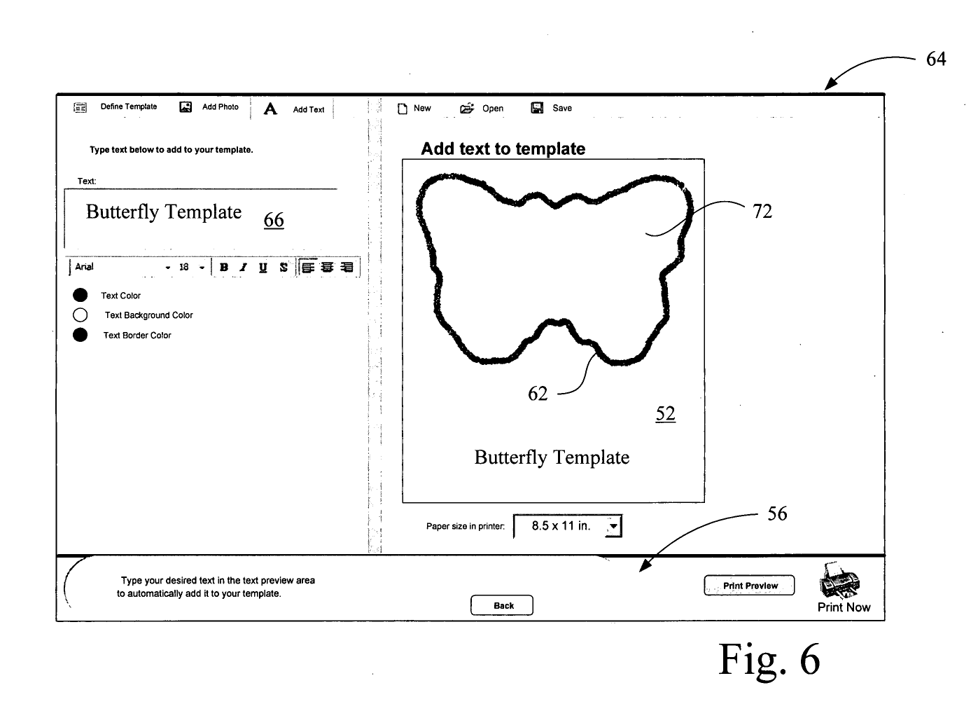

For example, by clicking on the Next button in lower bar 56, the process proceeds from menu screen 50 to a menu screen 64 as shown in FIG. 6, where the user is given the option to add text to preview region 52 via actuation of the Add Text button. The text may be included on the media sheet that will include perforation pattern 62. In the example of FIG. 6, the text “Butterfly Template” is typed into a text box 66. Thereafter, the user may drag the text to the desired location in preview region 52. In the present example, the text is inserted in preview region 52 outside of perforation pattern 62. Alternatively, or in addition to the above, text may be inserted in preview region 52 inside of perforation pattern 62, so as to appear in the perforated object once the perforated object is removed from the surrounding material of the media sheet.

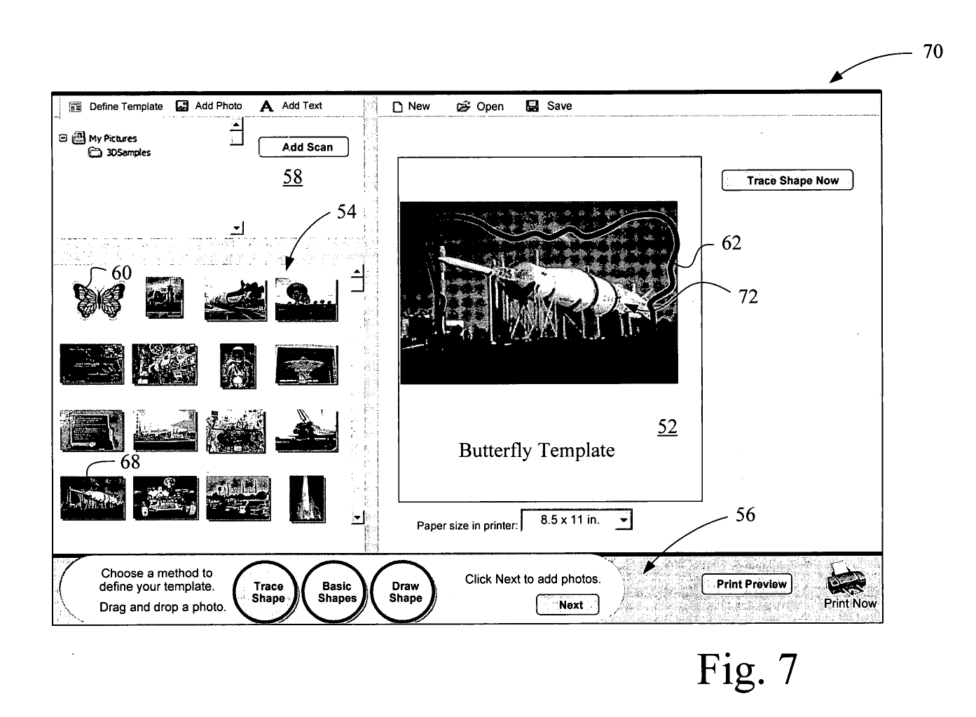

From menu screen 64, by clicking on the Next button in lower bar 56, the process proceeds to menu screen 70 as shown in FIG. 7, where the user is given the option to add a photo image, or alternatively a graphics image, to preview region 52 via actuation of the Add Photo button. In doing so, an image may be inserted into an interior region 72 defined by the perforation pattern 62, if desired.

At step S104, a user previews the combined image of the perforation pattern 62, and the image(s), e.g., photo 68, inserted in step S102. If desired, the user may discard any portion of the image that exceeds the boundary defined by perforation pattern 62. The preview takes place, for example, on display screen 38 of host 14 and/or display screen 27 of imaging apparatus 12. Alternatively, the previewing may be performed as a preview on a hard-copy printout produced by printing unit 22.

At step S106, a perforation operation is performed to perforate perforation pattern 62. In the example of FIG. 7, the combined image, i.e., the perforation pattern 62 along with the image data of photo 68, is perforated along the perforation pattern 62. Printing may be preformed, for example, while forming perforations in the sheet of media.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for generating a perforation clip region, comprising:
defining a shape of a desired perforation pattern on a display screen;
inserting at least one image onto said display screen in association with said perforation pattern; and
previewing a combined image of said perforation pattern and said at least one image.

2. The method of claim 1, wherein said perforation pattern is automatically created by determining a boundary of an object from a pre-existing image.

3. The method of claim 2, wherein said pre-existing image is retrieved from a database of images.

4. The method of claim 2, wherein said perforation pattern is stored in a database of perforation patterns.

5. The method of claim 1, wherein said perforation pattern is manually traced around a pre-existing image.

6. The method of claim 5, wherein said pre-existing image is retrieved from a database of images.

7. The method of claim 5, wherein said perforation pattern is manually traced using a pointer input device.

8. The method of claim 1, wherein said perforation pattern is a basic shape.

9. The method of claim 1, wherein said at least one image is a photo retrieved from a database of photos.

10. The method of claim 1, wherein said at least one image is a graphics image.

11. The method of claim 1, wherein said at least one image is text.

12. The method of claim 1, wherein said previewing is performed as a preview on a display screen.

13. The method of claim 1, wherein said previewing is performed as a preview on a hard-copy printout.

14. The method of claim 1, further comprising perforating said combined image along said perforation pattern.

15. The method of claim 1, wherein said at least one image is inserted into an interior region defined by said perforation pattern.

16. An imaging apparatus, comprising:
a display screen
a printing unit;
a perforating unit;
a processor communicatively coupled to said display screen, said printing unit and said perforating unit, said processor processing job data for use by at least one of said printing unit and said perforating unit; and
said processor executing program instructions for:
defining a shape of a desired perforation pattern on said display screen;
inserting at least one image onto said display screen in association with said perforation pattern; and
previewing a combined image of said perforation pattern and said at least one image.

17. The imaging apparatus of claim 16, wherein said at least one image is inserted into an interior region defined by said perforation pattern.

18. The imaging apparatus of claim 16, wherein the acts of defining, inserting and previewing are conducted interactively with a user via a series on menus screens displayed on said display screen.

19. The imaging apparatus of claim 18, wherein the act of defining includes displaying on said display screen a plurality of selectable options for selecting said desired perforation pattern.

20. The imaging apparatus of claim 18, wherein the act of inserting includes displaying on said display screen a plurality of selectable images.

21. The imaging apparatus of claim 20, wherein said plurality of selectable images include at least one of a photo, a graphics image and a text image.

22. The imaging apparatus of claim 18, wherein the act of inserting includes generating a text image.

23. An imaging system, comprising:
a host;
an imaging apparatus communicatively coupled to said host, said imaging apparatus including a printing unit and a perforating unit;
a processor is associated with at least one of said host and said imaging apparatus, said processor being communicatively coupled to said printing unit and said perforating unit, said processor executing program instructions for:
defining a shape of a desired perforation pattern on a display screen;
inserting at least one image onto said display screen in association with said perforation pattern; and
previewing a combined image of said perforation pattern and said at least one image.

24. The imaging system of claim 23, wherein said at least one image is inserted into an interior region defined by said perforation pattern.

25. The imaging system of claim 23, wherein the acts of defining, inserting and previewing are conducted interactively with a user via a series on menus screens displayed on said display screen.

26. The imaging system of claim 25, wherein the act of defining includes displaying on said display screen a plurality of selectable options for selecting said desired perforation pattern.

27. The imaging system of claim 23, wherein the act of inserting includes displaying on said display screen a plurality of selectable images.

28. The imaging system of claim 27, wherein said plurality of selectable images include at least one of a photo, a graphics image and a text image.

29. The imaging system of claim 23, wherein the act of inserting includes generating a text image.
